(19) United States
(12) Patent Application Publication
(10) Pub. No.: US 2005/0080799 A1
(43) Pub. Date: Apr. 14, 2005

(54) Real-time information collection and distribution system for robots and electronically controlled machines

(75) Inventors: James C. Harnden, Brookfield, WI (US); James W. Winfree, Waukesha, WI (US); Mark Lawrence Hornick, Cedarburg, WI (US); John O. Borchardt II, Milwaukee, WI (US); Mark A. Skerencak, Waukesha, WI (US); Robert C. Gehred, (US)

Correspondence Address: BURNS DOANE SWECKER & MATHIS L L P, POST OFFICE BOX 1404, ALEXANDRIA, VA, 22313-1404, US

(73) Assignee: ABB Flexible Automaton, Inc., New Berlin, WI (US)

(21) Appl. No.: 10/965,861

(22) Filed: Oct. 18, 2004

Related U.S. Application Data
(63) Continuation of application No. 09/323,352, filed on Jun. 1, 1999, now abandoned.

(51) Int. Cl. G06F 7/00

(52) U.S. Cl. 707/100

(57) ABSTRACT

A system for collecting and distributing information to and from a plurality of electronically controlled machines. The system is designed to collect information from robots, industrial machines, and other types of equipment that produce real-time information. The machines are coupled to a data collector module using a public domain communication protocol. The data collector module is coupled in data communication to a main server which has a mechanism for publishing the data received from the electronically controlled machines over a network to one or more clients. The main server also has an authenticator for verifying the identity of clients accessing the system through the network, and a communication module for streaming the data from the electronically controlled machines. Information and programming may also be transferred from the clients to the machines through the system to allow remote control of the machines.

### FIELD OF THE INVENTION

The present invention relates to methods and systems used to collect information from and distribute information to robots and other electronically controlled machines. In particular, the present invention relates to a method and system for remotely monitoring and controlling such devices using Transmission Control Protocol/Internet Protocol (TCP/IP), Hyper Text Transfer Protocol (HTTP), and related protocols.

### BACKGROUND OF THE INVENTION

Industrial robots and similar machines are used to carryout a wide variety of tasks such as welding, painting, sorting, and package and component handling. In the majority of cases, it is desirable to monitor the machine, its condition, and any ancillary equipment to ensure that it is performing its task properly and operating within its designed performance envelope. While monitoring may be done manually by an operator watching gauges, displays, and the like, coupling the machine to a computer permits remote monitoring. With a properly designed remote monitoring system, one operator can monitor numerous devices. Monitoring can be accomplished at a safe distance from the machines, be done continuously, and a historical performance record of the machine can be easily created.

While remote monitoring is useful, remote control of machines is also of value. Like remote monitoring, remote control allows one person to operate multiple machines, adjusting them (by, for example, modifying the program executed by them) to correct deviations from desired performance criteria.

While there are systems that permit the remote monitoring and control of robots and other machines, present systems are not satisfactory for many applications. Often times such systems rely on proprietary technology to transfer and gather information. Utilizing robots and machines with proprietary communication technology can be costly and time consuming. Further, such robots and machines are often difficult to interconnect with other computer devices which may be used in an automated facility. Further still, in present systems, remote control can not be easily accomplished from outside the facility in which the robots or machines are located. Thus, for example, a repair specialist from a vendor company can not normally access the control and monitoring system without travelling to the facility having the robots and machines of interest. Accordingly, it would be desirable to have a remote control and monitoring system without these drawbacks.

### OBJECTS AND SUMMARY OF THE INVENTION

Therefore, it is an object of the present invention to provide an improved system designed to collect and distribute information to and from electronically controlled machines such as robots.

It is another object of the present invention to provide an improved system that utilizes open protocols for communicating between clients and servers in the system.

It is another object of the present invention to provide a system that permits long distance, remote monitoring of electronically controlled machines.

These and other objects are achieved in a system that includes a data collector module, which in one embodiment is loaded on a data collector server, although it may reside on a in server (discussed below). No matter where the data collector module resides, it processes information received from a plurality of electronically controlled machines such as robots and communicates with those machines using a public domain communication protocol such as a Remote Procedure Call protocol (where a process on the local system invokes a procedure on a remote system). The data collector module transfers the information it collects from the machines to software modules on the main server using an application level interface. The main server includes means for publishing data received from the data collector module to clients through a wide-area network such as the Internet. The main server also includes an authenticator for verifying the identity of clients accessing the system through the wide-area network and a communication module interface for formatting the real-time information received from the machines.

So designed, the present invention permits the remote monitoring and control of the machines communicating with the data collector module. The means for publishing information on the main server is designed to permit the display of real-time information from the machines, something that is generally not possible with present systems. Further, the machines may be controlled by using information and programs from the clients, communicated to the machines through the main server and data collector.

These are just some of the features and advantages of the present invention. Many others will become apparent by reference to the detailed description of the invention taken in combination with the accompanying drawings.

### BRIEF DESCRIPTION OF THE DRAWINGS

In the drawings:

FIG. 1 is a schematic diagram of an information collection and distribution system made in accordance with the teachings of the present invention showing a remote client and a local client coupled to a main server which receives data through a data collector module from a plurality of electronically controlled machines, and a locator.

FIG. 2 is a schematic diagram of the architecture of the software run on the main server.

FIG. 3 is a schematic diagram of the architecture of the data collector module in one embodiment of the present invention.

FIG. 4 is a schematic diagram of the architecture of the data collector module in another embodiment of the present invention.

FIG. 5 is a schematic diagram of the architecture of the software run by the local and remote clients.

FIG. 6 is a schematic diagram of the architecture of the software run by the locator.

### DETAILED DESCRIPTION

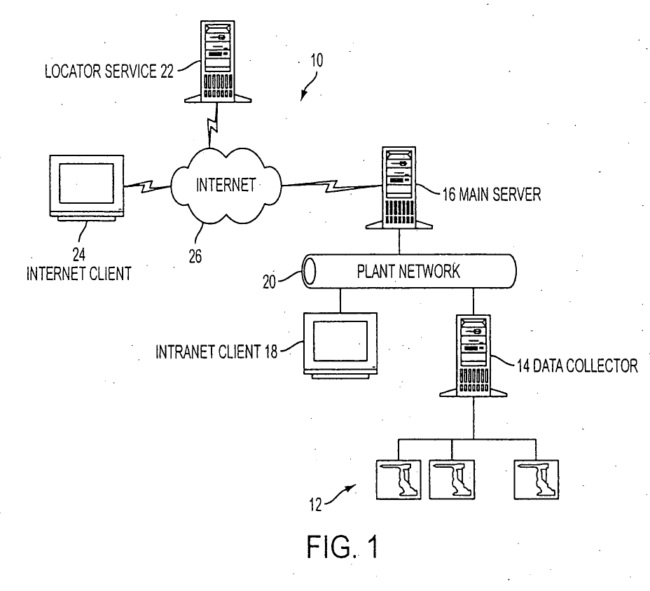

An information collection and distribution system 10 is shown schematically in FIG. 1. The system includes a plurality of electronically controlled machines 12, each having a controller (not shown). The machines 12 are illustrated as industrial robots, but may be other machines such as CNC machines, machines controlled by PLCs, and the like. In one embodiment, the machines 12 are coupled to a data collector server 14 on which a data collector module resides. The data collector server 14 is coupled to a main server 16 and a local client 18 (such as a personal computer) through a local area network 20. The main server 16 is coupled to a locator 22 and a remote client 24 through a wide area network 26, such as the Internet.

One of the advantages of the present invention is that it utilizes Internet compatible protocols. Using these types of protocols permits the system to be easily expanded or extended. For example, although not shown, multiple data collectors coupled to multiple, individual sets of machines could be linked to the main server 16. In addition, since an open network protocol such as TCP/IP is used as the communication link between the main server and clients, multiple main servers (not shown) and multiple clients, both remote and local (not shown), could be employed to create a large system covering multiple facilities. Yet, as will be described in more detail below, the present invention provides sufficient security to prevent unauthorized access to the machines and computers used in the system. Because Internet technologies play an important part in the invention, a brief description regarding them is in order. It should be understood, however, that those of ordinary skill in the art understand such technologies.

The Internet is based, in large part, on the client-server model of information exchange. To ensure proper routing of messages between the server and the intended client, Internet messages are first broken up into data packets, each of which receives a destination address according to a consistent protocol. The data packets are sent over communication links such as telephone lines and then reassembled upon receipt by the target computer. Internet Protocol dictates routing information; and transmission control protocol governs message parsing into IP packets for transmission, subsequent collection, and re-assembly.

In addition to TCP/IP, the Internet supports other information-transfer protocols. One of these is called HyperText Transfer Protocol (HTTP) and is the basis of the World Wide Web (“web”). Web-accessible information is identified by a uniform resource locator which specifies the location of the resource in terms of a specific computer and a location on that computer. Any computer with an IP address (e.g., a server permanently and continuously connected to the Internet, or a client that has connected to a server and received a temporary IP address)—can access the resource by invoking the proper communication protocol and specifying the URL. Typically, a URL has the format http://<host>/<path>, where “http” refers to HyperText Transfer Protocol, “host” is the server's Internet identifier, and “path” specifies the location of the resource within the server. Each “web site” can make available one or more web “pages” or documents, which are formatted, tree-structured repositories of information, such as text, images, sounds and animations.

“Hypertext” and linking are two important features of HTTP. Hypertext and searching functionality are typically implemented on the client machine, using a “web browser.” With the client connected as an Internet node, the browser utilizes URLs—provided either by the user or a link—to locate, fetch, and display the specified resources. The browser passes the URL to a protocol handler on the associated server, which then retrieves the information and sends it to the browser for display; the browser causes the information to be cached (usually on a hard disk) on the client machine. The web page itself contains information specifying the specific Internet transfer routine necessary to retrieve the document from the server on which it is resident. Thus, clients at various locations can view web pages by downloading replicas of the web pages, via browsers, from servers on which these web pages are stored. Browsers also allow users to download and store the displayed data locally on the client machine.

Most web pages are written in HyperText Markup Language (HTML) or as Active Server Pages (ASP). HTML breaks the document into syntactic portions (such as headings, paragraphs, lists, etc.) that specify layout and content. An HTML file can contain elements such as text, graphics, tables, and buttons, but such information is generally static. An object-oriented programming language known as Java and ASP files facilitate dynamic display of information. Java-encoded “applets” are stand-alone programs embedded within web pages that can interact with the user locally, display-moving animations, and perform other functions on “Java-capable” browsers—that is, browsers which include a Java interpreter. The applet can be installed locally or transferred to the browser along with other web-page information and is executed by the Java interpreter. The data acted upon by the applet can be located on the same or a different web page, or a different server entirely, since applets can themselves cause the browser to retrieve information via hypertext links.

ActiveX controls can be used as an alternative to Java and also require compatible browsers and computers. These software components can be written in many computer languages (including Java) and usually compile to machine code, in which case they operate only in conjunction with browsers running machines with appropriate processor architectures. Some languages, however, will compile to machine-independent byte codes, which can run on a variety of processor architectures.

The key to the concept of a web page is the division of functionality between the client-based browser and the server-based web page, and the particular roles assigned to each. The browser locates, fetches, and displays resources, executes hyperlinks and applets, and generally interprets web-page information. The web page contains data, hyperlink addresses, transfer protocols, and computer instructions that may be executed by the browser. Ordinarily, web pages reside on servers accessible via the Internet. However, the above-discussed mode of splitting functions between web pages and browsers can be instituted on internal networks as well. These internal networks are often called “intranets.” Computers forming an intranet can be utilized as servers for web pages, each page with its own URL and offering access to network client computers via TCP/IP and HTTP.

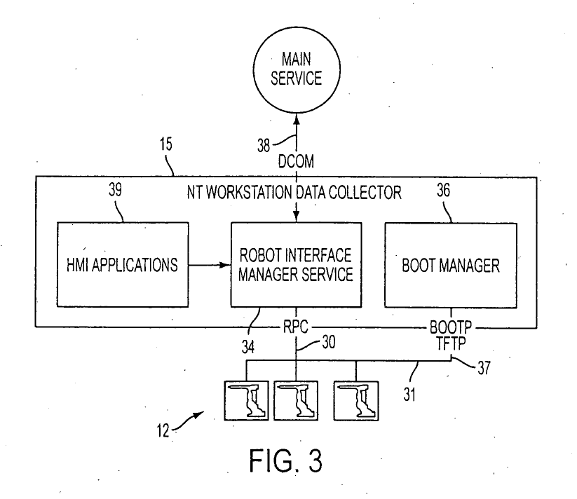

As best seen by reference to FIG. 3, in the present invention the plurality of electronically controlled machines 12 communicate with the data collector module 15 using a Remote Procedure Call (RPC) protocol over a main branch 30 of a network 31. The data collector module 15 may reside on its own server, the data collector server 14 as shown (FIG. 1), or it may reside on the main server 16 (FIG. 1). Regardless of its location, the data collector module 15 collects information from the machines 12 and, as described in more detail below, populates a dynamic data store, machine log database, and machine program file cache in the main server 16. As will be described in greater detail below, the data collector module may also transfer information from the clients to the machines 12 to provide remote control.

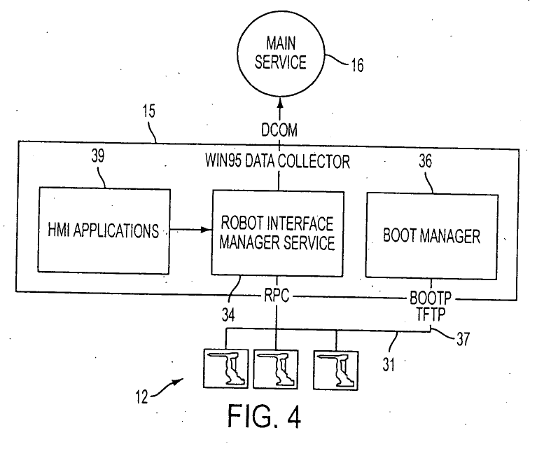

In most applications, the module 15 is designed for a robust operating system such as the Microsoft® NT Workstation operating system, but it also supports other versions of Windows operating systems (see FIG. 4). In order to support network booting of the electronically controlled machines 12, the data collector module 15 includes a boot manager 36 which manages and distributes the operating software required by the machines 12 through a branch 37 of the network 31 using BOOTP/TFTP (Bootstrap Protocol/Trivial File Transfer Protocol) Run-time and operational data from the machines 12 is delivered through the network 31 to an interface manager (InterLink) service 34. When the machines 12 are robots, the interface manager service 34 is a robot interface manager service.

The interface manager service 34 monitors the file systems in the machines 12. As machine files are updated with new information, the files are automatically uploaded to the machine file program cache (discussed below) in the main server 16. The interface manager service 34 also handles write requests from controllers in the machines 12 while the main server 16 is used to increment named machine log counters and to start and stop named machine log timers. Counters and timers can be used to create a log of process statistics such as parts produced within given time periods and the duration of process events, which can be timed by the machines 12 or the data collector module 15. In the NT embodiment of the present invention, the interface manager service 34 is based on an ActiveX Template Library (ATL) and uses a DCOM (Distributed Component Object Model) server interface to transfer data to the main server 16. In this embodiment, the interface manager service 34 is started by the operating system during boot. If the data collector module 15 is used within the Win9x operating system (as shown in FIG. 4), the interface manager service 34 must be started manually.

In addition to the functions discussed, the data collector module 15 stores Human Machine Interface (HMI) applications 39. These applications are used as operator stations and can co-exist with the interface manager service 34 on the same hardware. Further still, these user-interface screens can be exported by the main server 16 to provide a remote user with essentially the same user-interface presented to a local user.

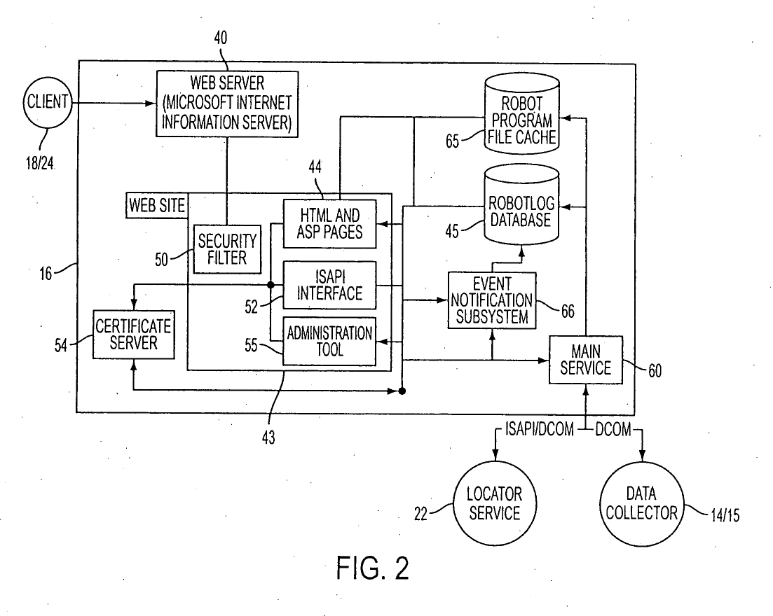

Once the main server 16 obtains information from the data collector module 15, it makes that information available for access by the local client 18 and remote client 24 (by publishing it). As shown in FIG. 2, to serve the clients 18 and 24, the main server 16 includes a web server 40 such as the Microsoft® Internet Information Server (IIS). The information accessed by the clients is organized in a web site 43. The site consists of a security filter (discussed below), command interface (also discussed below), and a set of HTML and ASP (Active Server Pages) pages, images, JAR (Java Archive) files, ISAPI DLLs (Internet Server Application Programming Interface Dynamically Linked Libraries), and other files utilized by the web server 40, collectively designated as site files 44. The web site 43 obtains information from a machine log database 45. The main server 16 includes a variety of other modules which perform administration, tracking, management, and enforcement functions. To ensure that only authorized clients access the information on the main server 16, a security filter 50 monitors access to the site files 44 and the Internet Server Application Programming Interface (ISAPI) command interface 52. The security filter 50 is a combination of features from the command interface 52, web server 40, and certificates from a certificate service 54. Once the security filter 50 has authorized the client, it permits access to the privileged information contained in the ASP pages and site files 44 and the command interface 52 so that access by the authorized client is tailored to the privileges granted to the client by the site administrator. Privileges are set and stored by the administrator in an administration tool 55. The administration tool 55 is used to configure the main server 16 and to perform typical administrative functions such as granting, modifying, and revoking user access to information; general database maintenance (purging old records, deleting machine information, etc.); applying patches to the main service module (discussed below); maintaining and configuring machine program cache operation; installing and controlling execution of business rule enforcement applications; and software license policing.

In addition to providing a portion of the security filter 50, the command interface 52 performs other functions. The command interface 52 includes a communication module in the form of a DLL that is used to present live, dynamically-changing data to web pages viewed by the clients 18 and 24. In other words, the command interface 52 supports data streaming to the clients 18 and 24. This allows presentation of the data without requiring refreshing of the pages viewed. Commands are sent to the DLL of the command interface 52 using HTTP messages and results are returned as formatted HTML text. The DLL parses the commands and executes the commands using an Internet Active Server Page/Application Programming Interface (IASPAPI) COM (Component Object Model) interface.

To manage the information obtained from the machines 12, the main server 16 includes a main service module 60. The main service module 60 is implemented using ATL and presents COM/DCOM/ISAPI interfaces to expose encapsulated data received from the machines 12. More specifically, the main service module 60 includes a dynamic datastore (not shown) that maintains the current state of the data collector and machine controllers. This information is obtained from the data collector 14 through a DCOM interface 62 and is stored internally in the dynamic datastore. The state information is not saved when the system is shut down. The ASP pages and ISAPI DLLs access the state information in the dynamic datastore using an IASPAPI COM interface.

The data collector state values stored by the dynamic datastore include IP address, attached machine list, data collector software version, operating system and version, and capability list (which indicates whether the data collector 14 functions as a DCOM server, or other type of server). The machine controller state values stored by the dynamic datastore include the current control status (operational state, control state, program state, and program controller state); I/O configuration (list of all I/O boards and signals); I/O state (current values for all digital and analog signals); control identification (which includes controller id, boot prom version, RAP interface version, TPU version, and system software version); cached program variable values (which include program variable values selected by the machine application program or by the system administrator); machine IP address; and machine interface configuration/state (which includes average poll rate, and poll delay duration).

Another component of the main service module 60 is the software licensing scheme. Similar to many other commercially available products, the main service module 60 supports various hardware and software policing devices including hardware dongles and password protection.

The main service module 60 stores various information it receives from the machines 12. One storage mechanism used by the tracking module is the machine program file cache 65. The program file cache 65 is a set of directories where the contents of the file systems of the attached machine controllers can be stored. The data collector module 15 periodically checks for file changes and uploads the changed files to the main service module 60, which stores that data in the program file cache 65. The program file cache 65 uses three directories for each machine controller: a current directory which contains an up-to-date copy of the current files found on the machine controller; a program safe directory which contains images saved by the machine operator; and a gold directory which contains archived versions of the program files that are saved and labeled by the site administrator. There can be multiple gold copies to represent multiple releases. An operator can copy files from a gold directory, but only an administrator can copy files to a gold directory. These directories can be accessed, with proper authorization, by a client through pages on the web site 43 or by requesting a file download from the machines 12.

Another storage mechanism used by the main server 16 is the machine log database 45. The machine log database 45 stores various table, timer, and counter information produced by the machines 12. In particular, the machine log database 45 contains a machine name table with all of the names of the machines 12 attached to the system 10; a machine log table containing all of the machine log events received from each attached machine controller; and a counter table that maintains named counter values. A new counter record is created periodically, such as every hour the counter is active. The machine application programs create the counters and update the active counter records. The counters may be used to count program errors, cycles, part completions, etc. The web site 43 contains generic report screens to display counter statistics.

The machine log database 45 also maintains named timer values for each machine 12. These timers are used to time application or process events. As with the counters, the machine applications create the timers and the web site 43 contains generic report screens to display timer statistics. The timers are used by the system 10 to track data collector connection time and machine uptime. The machine log database 45 may be populated by the data collector module 15 communicating through the main service module 60. It may be accessed by the web site pages to report on the activity of the machines 12 and is maintained through the administration tool 55.

The main server 16 also includes an event notification system 66 (FIG. 2). The event notification system 66 is a user configured software module that provides user notification of system and process events utilizing standard notification mechanism such as e-mail and paging. The event notification system 66 can be used to complete a variety of tasks such as production and error reporting via e-mail and to page service personnel when fatal errors are experience by the machines 12.

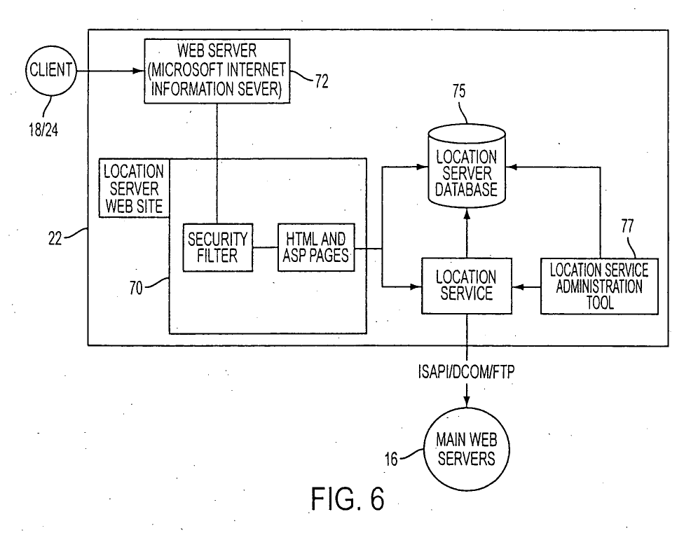

As noted above, the system 10 may include multiple clients, both remote and local, and multiple sets of machines, data collectors/data collector modules, and main servers. Furthermore, the system 10 may be implemented at multiple locations. Thus, it is possible that many main servers could be coupled to the Internet. Provided that the URL is known, it would be possible for any of the remote clients to access any of the main servers. Of course, the servers at one location are likely to be owned by an organization which is independent of the organizations which own servers at other locations. The locator 22 (FIG. 6) is used to control access to the main servers 16 coupled to the network 26. The locator 22 includes an Internet web site 70, which typically would be created and maintained by the system vendor, and a web server 72. The locator 22 has a known registered domain name and can be accessed by anyone connected to the network 26. The site 70 manages a list (stored in a server database 75) of all the main servers 16 currently connected to the network 26. The site provides secure access to this list (through an administration tool 77) and redirects authenticated users to the main server 16 they wish to browse.

More specifically, the locator 22 authenticates each client and presents each client with a page of hyperlinks pointing to the main servers that the client is allowed to access. To accomplish this, the locator 22 includes a client interface that authenticates clients using certificates and an SSL (Secure Sockets Layer) protocol. The certificates are public and private encryption keys that include a description of the bearer of the certificate. These are created by the system 10 administrator and are authenticated by the web server 4Q when a client browser enters a secured conversation with the server of interest. All clients are identified using the public certificate keys.

Once a client has connected to the main server 16 (which may or may not occur through the locator 22), the identity of the client is reviewed. In order to identify the client location (i.e., whether it is an Internet client or an intranet client) the source IP address of the client's browser is inspected. The administration tool 55 searches for IP subnets that are located inside the facility. Any 1P address not found to be in a known subnet is considered to be located on the Internet.

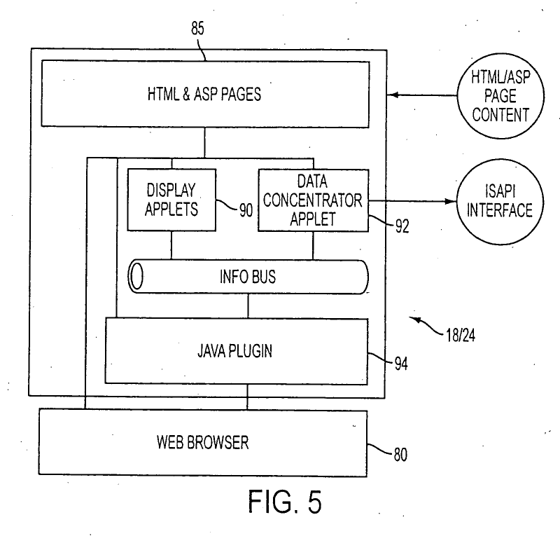

To this point the details of the data collector 14, main server 16, and locator 22 have been emphasized. The architecture of the clients 18 and 24 is shown in greater detail in FIG. 5. Each client includes a web browser 80 (such as Netscape Communicator or Microsoft Explorer browsers), a stored web content 85 in the form of HTML and ASP pages, and modules to display that content such as display applets 90, a data concentrator applet 92, and plugins 94. When the clients 18 and 24 receive information it is streamed to the client displays in a manner as described above. In most cases, safety precautions make it impractical to allow remote control of the machines 12, but commands and software to run the machines may be sent from the clients to the machines through the main server 16 and data collector 14 (or in the case of a local client just through the data collector).

It will therefore be seen that the foregoing represents a highly extensible and flexible approach to remote access to and presentation of machine information as well remote control of the machines themselves. The examples, terms, and expressions employed herein are used as terms of description and not of limitation, and there is no intention, in the use of such descriptions, terms, and expressions, of excluding any equivalents of the features shown and described or portions thereof, but it is recognized that various modifications are possible within the scope of the invention claimed.

1. A system for collecting and distributing information to and from a plurality of electronically controlled machines, each machine producing real-time information, the system comprising:
a data collector module coupled in data communication to the electronically controlled machines for receiving data from the electronically controlled machines;
a main server coupled in data communication to the data collector module and to a network, the main server having means for publishing the data received from the electronically controlled machines, an authenticator for verifying the identity of clients accessing the system through the network, and a communication module capable of transmitting from the main server the data from the electronically controlled machines;
a database on the server, in which database is stored data received via the data collector module from the electronically controlled machines;
the main server further having the capability of permitting a client to access the database through the network and substantially preventing the client from accessing the electronically controlled machines directly;
a client capable of accessing the database through the network; and
a locator coupled to the main server through the network and for directing communication between the main server and the client.

2. A system as in claim 1, wherein the data collector module communicates with the machines using a communications protocol wherein the communications protocol is DCOM, HTTP, ETP, RPC or a proprietary protocol.

3. A system as in claim 1, wherein the data collector module further comprises an interface manager service to transfer data to the main server.

4. A system as in claim 1, wherein the data collector module is coupled in data communication to the electronically controlled machines by means of a communication protocol.

5. A system as in claim 1, wherein the network is a wide area network.

6. A system as in claim 1, wherein the main server is also coupled to a local-area network and further comprising a second client coupled to the local-area network.

7. A system as in claim 1, wherein the main server includes an event notification system.

8. A system for collecting and distributing information to and from multiple sets of electronically controlled machines, each machine producing real-time information, the system comprising;
a plurality of data collectors, each data collector coupled in data communication to a single set of electronically controlled machine and having an interface manager service;
a plurality of main severs, each main server coupled in data communication to one or more data collectors using a DCOM-compliant protocol and a wide area network, each main server having means for publishing the data received from the one or more data collectors coupled to it, an authenticator for verifying the identify of clients accessing the system through the wide-area network, and a communication module capable of transmitting from at least one of the main servers the data from the electronically controlled machine;
a locator coupled to each of the main servers through the wide area network and for directing communication between the main servers and their respective clients;
at least one database on at least one of the main servers, in which at least one database is stored data received from at least one of the data collector modules; and
at least one of the main servers being capable of permitting at least one client to access the at least one database through the wide area network and substantially preventing the at least one client from accessing the electronically controlled machines directly.

9. A system as in claim 8, wherein the data collectors each transfer data to and from the main servers.

10. a system as in claim 8, wherein each main server is also coupled to a local-area network and further comprising at least one client coupled to the local-area network.

11. A system for collecting and distributing information, the system comprising:
a plurality of electronically controlled machines;
at least one data collector module coupled in data communication to the electronically controlled machines;
at least one main server coupled in data communication to the at least one data collector module and a network, the main server having means for publishing the data received from the at least one data collector, an authenticator for verifying the identity of clients accessing the system through the wide-area network, and a communication module capable of transmitting from the at least one main server the data from the electronically controlled machines;
at least one database on the main server, in which database is stored data received from the at least one data collector module;
the at least one main server being capable of permitting a client to access the at least one database through the wide are network and substantially preventing the client from accessing the electronically controlled machines directly; and
a locator coupled to the main server through the network and for directing communication between the main server and the client.

12. A system as in claim 11, wherein the data collector module communicates with the machines using a communications protocol.

13. A system as in claim 11, wherein the data collector module further comprises an interface manager service to transfer data to the main server.

14. A system as in claim 11, further comprising at least one client capable of accessing the at least one database through the network.

15. A system as in claim 11, wherein the network is a wide area network.

16. A system as in claim 11, wherein the main server is also coupled to a local-area network and further comprising a second client coupled to the local-area network.

17. A system for collecting and distributing information to and from a plurality of electronically controlled machines, each machine producing real-time information, the system comprising:
a data collector module coupled in data communication to the electronically controlled machines for receiving data from the electronically controlled machines;
a main server coupled in data communication to the data collector module and to a network, the main server having a publisher for publishing the data received from the electronically controlled machines, an authenticator for verifying the identity of clients accessing the system through the network, and a communication module for transmitting from the main server the data collected from the electronically controlled machines;
at least one data base on the main server, in which at least one database is stored data received from the data collector module;
the main server capable of permitting a client to access the at least one database through the network and substantially preventing the client from accessing the electronically controlled machines directly; and
a locator coupled to the main server through the network and for directing communication between the main server and the client.
